(19) United States
(12) Patent Application Publication
(10) Pub. No.: US 2007/0220427 A1
(43) Pub. Date: Sep. 20, 2007

(54) SKIN TONE MOBILE DEVICE AND SERVICE

(76) Inventors: Alain Charles Louis Briancon, Poolesville, MD (US); Peter B. Ritz, Rydal, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/668,903

(22) Filed: Jan. 30, 2007

Related U.S. Application Data
(60) Provisional application No. 60/763,296, filed on Jan. 30, 2006.

(51) Int. Cl. G06F 3/00; G06F 3/048

(52) U.S. Cl. 715/700; 715/764

(57) ABSTRACT

A portable electronic device having an adaptable skin covering a substantial portion of the portable electronic device and configured to display a customizable image. The image to be displayed may be input from a user of the portable electronic device, or may be transmitted to the portable electronic device through a wireless communication network. In a preferred embodiment, the adaptable skin is touch sensitive, and the skin image to be displayed includes indicia for selection. The adaptable display may be any adaptable display technology, including electrophoretic displays, electrowetting displays, dielectrophoresis displays, bistable LCDs, and preferably electrochromic displays. A wireless communication network and methods for providing skin images to a portable electronic device are also disclosed.

### CROSS REFERENCE TO RELATED APPLICATION

This application claims the benefit of U.S. provisional application No. 60/763,296, filed Jan. 30, 2006, which is incorporated by reference as if fully set forth.

### FIELD OF INVENTION

The present invention generally relates to portable electronic devices. More particularly, the present invention relates to a device, system, and method for providing customized skins for portable electronic devices.

### BACKGROUND

As the cost and complexity of portable devices has decreased, these devices have become ubiquitous throughout society. Such portable electronic devices include mobile phones, portable music players, personal digital assistants (PDAs), laptop computers, and the like. People have accepted these devices as part of everyday life. As such, people are demanding that these devices be customizable. For example, different wallpapers may be selected to provide a background for a device's display. Alternatively, a portable electronic device may have its external case (i.e. its skin) customized by application of different plastic casings. Adhesive sticker skins may also be printed then affixed to the portable electronic device. These types of customization do not affect the functionality of the device; they merely provide a rudimentary personalization of the device to the tastes of the user.

In a slightly more advanced manner, the functionality of an electronic device, such as a mobile phone, may be changed. For example, customization of ring tones may be selectively based on a variety of conditions including the identity of the incoming caller, the time of day, the location of the mobile phone, and the like. A mobile phone user may access a variety of ring tones that are typically offered for sale by the mobile phone's service provider. This also provides an additional source of income for the service provider.

Traditional displays, such as liquid crystal displays (LCDs), require a constant supply of power to maintain an image. Therefore, there has always been a tradeoff between maximizing the size of the display in order to maximize the functionality of the device and enhance the user experience, and minimizing the display in order to decrease the power requirements and battery drain.

In contrast, there is a new generation of displays that do not require a tradeoff between functionality and power management. Adaptable display devices only require power to change the image on the display. Once an image is written to a adaptable display, the power source may be removed without any effect on the written image. Electrochromic displays, bistable LCDs, electrophoretic displays, electrowetting displays, nemoptic displays, cholesteric LCDs, dielectrophoresis displays, and anisotropically rotating ball displays are a few examples of adaptable display technologies.

In order to prolong the battery life of a portable electronic device and maximize its functionality, it is desirable to incorporate adaptable displays in such a device. This is particularly useful in applications where it is not a requirement that the image be frequently updated.

### SUMMARY

The present invention includes a portable electronic device having an adaptable skin. The adaptable skin covers a substantial portion of the portable electronic device and is configured to display a customizable image. The image to be displayed may be input from a user of the portable electronic device, or may be transmitted to the portable electronic device through a wireless communication network. In a preferred embodiment, the adaptable skin is touch sensitive, and the skin image to be displayed includes indicia for selection. The adaptable display may be any adaptable display technology, including electrophoretic displays, electrowetting displays, dielectrophoresis displays, bistable LCDs, and preferably electrochromic displays. A wireless communication network and methods for providing skin images to a portable electronic device are also disclosed.

### BRIEF DESCRIPTION OF THE DRAWINGS

A more detailed understanding of the invention may be had from the following description, given by way of example and to be understood in conjunction with the accompanying drawings, wherein:

FIG. 1 is a portable electronic device having an adaptable skin in accordance with the present invention;

FIG. 2 is a schematic diagram of a direct drive electrochromic adaptable skin in accordance with the present invention;

FIG. 3 is a schematic diagram of an active matrix electrochromic adaptable skin in accordance with the present invention;

FIG. 4 is the portable electronic device of FIG. 1 displaying a loaded skin image file;

FIG. 5 is a block diagram of the portable electronic device of FIGS. 1 and 4;

FIG. 6 is a block diagram of a portable electronic device having an adaptable skin and touch screen functionality;

FIG. 7 is a block diagram of a portable electronic device having an adaptable skin and touch screen functionality, wherein the adaptable skin replaces a traditional display;

FIG. 8 is the portable electronic device of FIG. 7;

FIG. 9 is a wireless communication network capable of supporting skin image files on portable electronic devices;

FIG. 10 is a method for a user of portable electronic device to request skin image files; and

FIG. 11 is a method for providing skin image files to a portable electronic device based on the device's location.

### DETAILED DESCRIPTION OF THE PREFERRED EMBODIMENTS

As used herein, the term ‘adaptable’ when referring to either a display or a skin indicates that power is only required to change the image on the display. In other words, once an image is written to an adaptable display, the power source may be removed without any significant effect on the displayed image over a certain time period. It is noted that adaptable displays and skins may require periodic refreshing using low duty cycle refresh power, (for example, once an hour, once a day, or less frequently). Displays that are not adaptable require constant power to maintain a displayed image. Electrochromic displays, bistable LCDs, electrophoretic displays, electrowetting displays, nemoptic displays, cholesteric LCDs, dielectrophoresis displays, and anisotropically rotating ball displays are a few examples of adaptable display technologies. It is noted that electrochromic displays operate by changing the reduction states of a viologen. Viologens that have multiple reduction states are considered adaptable within the meaning described above because the viologen will maintain a given reduction state in the absence of an applied electrical charge.

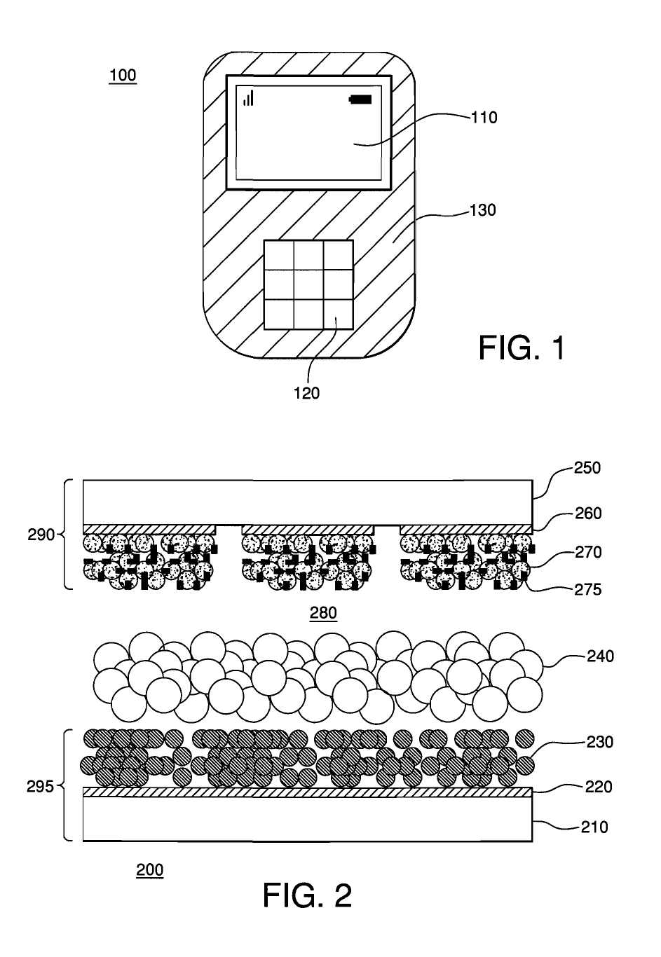

Referring to FIG. 1, a portable electronic device 100 is shown. For convenience, a cellular phone is shown; although the present invention applies to any type of portable electronic device 100. The portable electronic device 100 includes a display 110, an input device 120, and an adaptable skin 130. The display 110 may be used for displaying information to a user of the device. The display 110 will typically be an LCD, but may be any type of display. The input device 120 is shown as a numeric keypad, but may be any type of input device such as a keyboard or click wheel, based on the type and function of portable electronic device 100. Although not shown, the portable electronic device 100 may further include various input and output devices, such as a speaker, microphone, and the like, based on its functionality.

The adaptable skin 130 may be an electrochromic display, an LCD, an adaptable LCD, an electrophoretic display, an electrowetting display, a nemoptic display, a cholesteric LCD, a dielectrophoresis display, or an anisotropically rotating ball display. The adaptable skin 130 may comprise a plurality of pixels or segments. The pixels or segments may be directly driven by a dedicated or semi-dedicated routing track, or may be selectively driven using a matrix driving architecture, such as a passive or active matrix.

In a presently preferred embodiment, the adaptable skin 130 comprises an electrochromic display. Referring to FIG. 2, a segment driven adaptable electrochromic skin 200 comprises a base substrate 210 that supports a transparent conductor layer 220, which may be, for example, a layer of fluorine doped tin oxide (FTO) or indium doped tin oxide (ITO). The base substrate 210 is preferably flexible, however, it may also be molded to fit the contour of a selected portable electronic device. A nanoporous-nanocrystalline (nano-structured) semi-conducting film 230 is deposited, preferably by way of screen printing or ink jet printing, on the transparent conductor 220. The nano-structured film 230 is typically a doped metal oxide, such as antimony tin oxide (ATO). Optionally, a redox reaction promoter compound is adsorbed on the nano-structured film 230. An ion-permeable reflective layer 240, typically white titanium dioxide (TiO₂), is optionally deposited, again preferably by way of screen printing or ink jet printing followed by a sintering step, on the nano-structured film 230.

A second flexible substrate 250, which is transparent, supports a transparent conductor layer 260, which may be a layer of FTO or ITO. A nano-structured film 270 having a redox chromophore 275 adsorbed thereto is deposited on the transparent conductor 260, by way of a self-assembled mono-layer deposition from solution.

The semiconducting metallic oxide may be an oxide of any suitable metal, such as, for example, titanium, zirconium, hafnium, chromium, molybdenum, tungsten, vanadium, niobium, tantalum, silver, zinc, strontium, iron (Fe²⁺ or Fe³⁺) or nickel or a perovskite thereof. TiO₂, WO₃, MoO₃, ZnO, and SnO₂ are particularly preferred. Most preferably, the nano-structured film is titanium dioxide (TiO₂), and the adsorbed electrochromophore is a compound of the general formulas I-III:

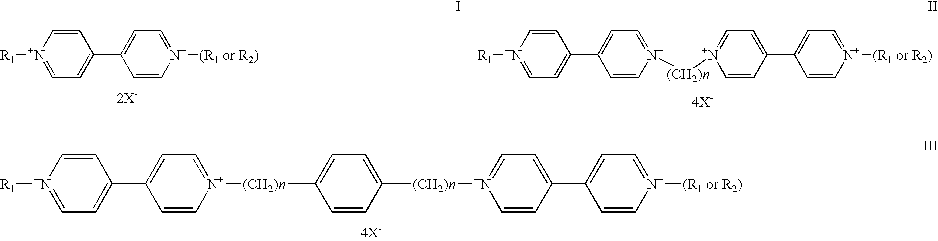

R₁ is selected from any of the following: 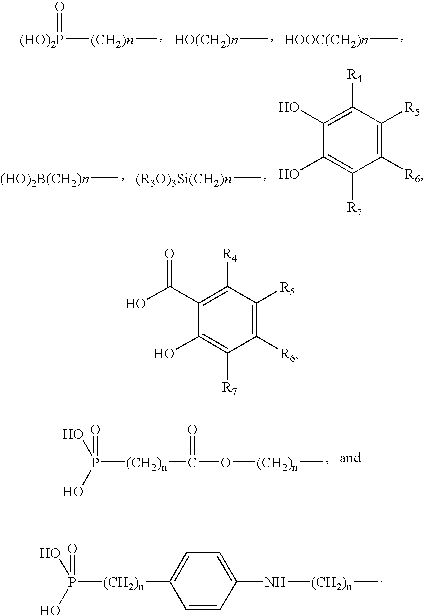
R₂ is selected from C₁₋₁₀ alkyl, N-oxide, dimethylamino, acetonitrile, benzyl, phenyl, benzyl mono- or di-substituted by nitro; phenyl mono- or di-substituted by nitro. R₃ is C₁₋₁₀ alkyl and R₄, R₅, R₆, and R₇ are each independently selected from hydrogen, C₁₋₁₀ alkyl, C₁N₀ alkylene, aryl or substituted aryl, halogen, nitro, and an alcohol group. X is a charge balancing ion, and n=1-10.

Compounds of the formulae I-III are well known and may be prepared as described in Solar Energy Materials and Solar Cells, 57, (1999), 107-125 which is hereby incorporated by reference in its entirety. In a preferred embodiment, the adsorbed electrochromophore is bis-(2-phosphonoethyl)-4,4′-bipyridinium dichloride.

The base substrate 210 and the second substrate 250 are then assembled with an electrolyte 280 placed between the ion-permeable reflective layer 240 and the nano-structured film 270 having an adsorbed redox chromophore 275. A potential applied across the cathode electrode 290 and the anode electrode 295 reduces the adsorbed redox chromophore 275, thereby producing a color change. Reversing the polarity of the potential reverses the color change. When the redox chromophore 275 is generally black or very deep purple in a reduced state, a user perceives a generally black or very deep purple color. When the redox chromophore 275 is in an oxidized state and generally clear, a user will perceive light reflected off of the ion-permeable reflective layer 240, which is generally white. In this manner, a black and white display is realized by a user.

Electrochromic display devices such as the one described above are described in greater detail in U.S. Pat. No. 6,301,038 and U.S. Pat. No. 6,870,657, both to Fitzmaurice et al., which are herein incorporated by reference.

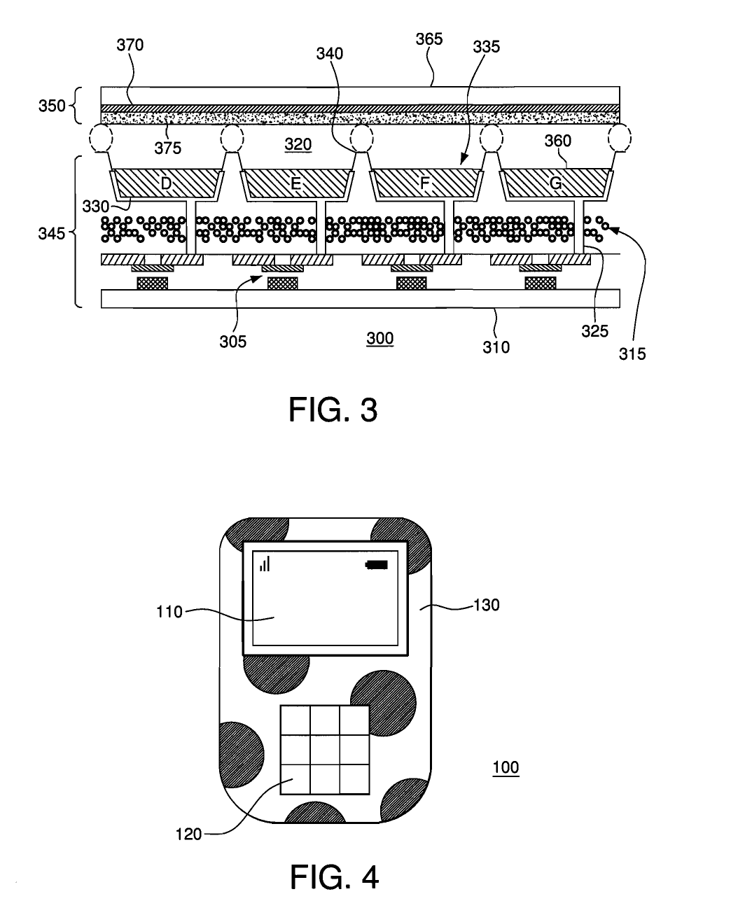

As mentioned above, the adaptable skin 130 may be a pixilated display driven by and active or passive matrix. In another preferred embodiment, the adaptable skin 130 is an active matrix electrochromic display. Referring to FIG. 3, an active matrix electrochromic adaptable skin 300 comprises a layer of active components 305 selectively deposited on a backplane substrate 310. The backplane substrate is preferably flexible, however, it may be molded to fit the contour of a selected portable electronic device. It should be noted that the electrochromic display 300 contains 4 pixels D, E, F, and G, purely for illustrative purposes. Preferably, the active components 305 are n-channel metal-oxide-semiconductor field-effect (NMOS) TFTs. Alternatively, the active components may be p-channel metal-oxide-semiconductor field effect (PMOS) TFTs, complementary-symmetry metal-oxide-semiconductor field effect (CMOS) TFTs, thin film diodes (TFDs), micro-electromechanical structures (MEMS), or any other type of active device capable of being matrix addressed for switching an electrochromic pixel.

An insulating layer 315 is deposited on the active components 305. The insulating layer 315 is substantially impermeable to the electrolyte 320, thereby protecting the active components 305 from the possible corrosive effects of the electrolyte 320. Preferably, the insulating layer 315 is a spin-coated polymer, such as polyimide. The insulating layer 315 is preferably reflective. The reflective property of the insulating layer 315 may be inherent in the material that comprises the layer, or reflective particles may be interspersed in the insulating layer 315.

An operable connection 325, known in the art as a via, is provided in the insulating layer for electrically connecting the drain of the active component 305 to a conductor 330. Preferably, the operable connection 325 is created via photolithographic techniques, which are well known to those skilled in the art. Each operable connection 325, or via, extends generally upwardly through the insulating layer 315 and is in electrical contact with a respective conductor 330, which preferably covers the bottom and the sides of a plurality of wells 335 formed or etched into the insulating layer 315. The operable connection 325 (i.e. via) and conductor 330 are preferably both transparent, and are preferably FTO or ITO.

The wells 335 are preferably etched in the insulating layer 315 using photolithographic techniques. Alternatively, the wells 335 are formed by mechanically embossing a deposited planar film or by application of a film containing a preformed waffle-type structure defining the wells 335.

Partitions 340 maintain electrical isolation of each well 335, and also allow the wells 335 to act as receptacles for ink-jet deposited materials. Partitions 340 may further act as a spacer between the cathode 345 and anode 350 of the adaptable skin 300, and serve to reduce ionic crosstalk between pixels through the electrolyte 320. The partitions 340 further serve the purpose of a visual boundary between each well 335, and may be sized as desired to achieve optimal appearance of each well 335. It is noted that although the partitions are shown as greatly extended generally above the wells 335, they may alternatively be generally flush with the top of the wells 335.

A semiconducting layer 360 having an adsorbed electrochromophore is deposited on the conductor 330. Preferably, the semiconducting layer 360 is a nano-structured metallic oxide semiconducting film, as described hereinbefore.

A frontplane substrate 365, which is substantially transparent, supports a substantially transparent conductor 370. The substrate 365 may be any suitable transparent material, and again may flexible or contoured. FTO, ITO, or any other suitable transparent conductor may be used for the transparent conductor 370.

A semiconducting layer 375 is deposited on the transparent conductor 370. Preferably, the semiconducting layer 375 is a nano-structured metallic oxide semiconducting film comprising Sb doped SnO₂. In an alternative embodiment, the semiconducting layer 375 includes an adsorbed redox promoter for assisting oxidation and reduction of electrochromic compounds adsorbed to the semiconducting layer 360 of the cathode 345.

The electrochromic display 300 is assembled by placing the anode electrode 350 onto the cathode electrode 345, ensuring that the two electrodes 345, 350 do not touch. Preferably, a flexible seal is formed around the perimeter, ensuring that the electrodes 345, 350 do not touch. Alternatively, physical separation of the cathode electrode 345 and the anode electrode 350 may be ensured by first depositing spacer beads 355 or other spacer structures as mentioned herein. The partitions 340 formed on the insulating layer 315 may also act to maintain a separation between the cathode electrode 345 and anode electrode 350. It should be noted that the anode electrode 350 covers the entire area of the pixels D, E, F, and G and is not segmented into individual areas corresponding to the area of the pixels D, E, F, and G. An electrolyte 320 is provided between the electrodes 345, 350, preferably by back-filling in a vacuum chamber.

An electric potential selectively applied across the cathode electrode 345 and the anode electrode 350 of a given pixel D, E, F, or G induces the flow of electrons in the semiconducting layer 360 having adsorbed electrochromophores. Upon oxidation and reduction, the adsorbed electrochromophores change color. In this manner, an active matrix electrochromic display is realized.

The active matrix electrochromic skin 300 is described in greater detail, along with various other architectures for realizing an active matrix electrochromic skin, in commonly assigned U.S. patent application Ser. No. 11/536,316, filed Sep. 28, 2006, which is herein incorporated by reference.

Referring to FIG. 4, the portable electronic device 100 displays a skin image file on its adaptable skin 130. The adaptable skin 130 is preferably an adaptable electrochromic skin, and may either be a direct drive display as described above with reference to FIG. 2, an active matrix display as described above with reference to FIG. 3, or a passive matrix display. The displayed skin image is a decorative dot pattern, and is purely exemplary. When the adaptable skin 130 is integral with the portable electronic device 100, a skin image file may be loaded into the portable electronic device 100 by means known to those of skill in the art, such as by a universal serial bus (USB) drive, flash memory storage, optical disk drive, and the like. When the adaptable skin 130 is contoured to fit the outer case of the portable electronic device 100, an electrical interface (not shown) may be provided for loading skin images and controlling the adaptable skin's 130 segments or pixels.

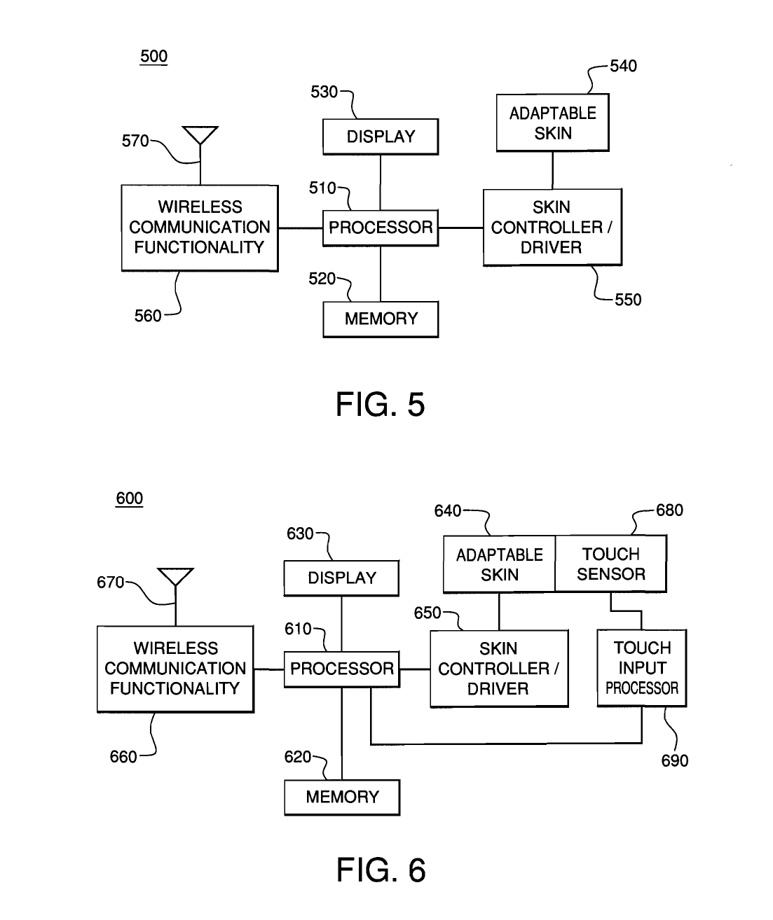

Referring to FIG. 5, a block diagram of the portable electronic device 500 in accordance with the present invention, as described with reference to FIGS. 1 and 4, is shown. The portable electronic device 500 includes a processor 510, memory 520, display 530, adaptable skin 540, skin controller/driver 550, and wireless communication functionality 560 including an antenna 570. The processor 510 controls all functions of the adaptable skin 540. The processor may also control other functions of the portable electronic device 500. Memory 520 is configured to store skin image files and related skin image file parameters. Skin image file parameters include size of the image, resolution, cost, and the like. Display 530, typically an LCD, is configured to display information to a user of the device 500.

The adaptable skin 540 substantially covers the outer shell of the portable electronic device 500. A skin controller/driver 550 drives and controls the adaptable skin 540. For example, when the adaptable skin 540 contains a plurality of addressable pixels electrically coupled by an active matrix, the skin controller/driver 550 controls the active matrix. All functions relating to driving potentials, driving waveforms, feedback control, and the like are handled by the skin controller/driver 550.

As previously mentioned, portable electronic device 500 is, purely by way of example and in no way meant to limit the scope of the present invention, a mobile telephone. Wireless communication functionality 560 is provided for interfacing with a wireless communication network. The wireless communication functionality 560 includes the necessary circuitry for interfacing with one or more wireless communication networks, including, but not limited to, 3^{rd} Generation Partnership Project (3GPP) networks, IEEE 802.x networks, Bluetooth® enabled devices, Global System for Mobile Communications (GSM)/Enhanced Data Rates for GSM Evolution (EDGE) networks, and the like. Wireless communication functionality 560 may also include global positioning system (GPS) functionality for determining the portable electronic device's 500 location. Antenna 570 provides access to the air interface of the selected wireless communication network(s).

In another preferred embodiment, touch screen functionality is incorporated into the skin of a portable electronic device. Referring to FIG. 6, a block diagram of a portable electronic device 600 having touch screen functionality is shown. The portable electronic device 600 includes a processor 610, memory 620, display 630, adaptable skin 640, skin controller/driver 650, and wireless communication functionality 660 including an antenna 670, similar to the portable electronic device 500 described with reference to FIG. 5. A touch sensor 680 is provided for sensing pressure applied to selected regions of the skin of the portable electronic device 600. Touch sensors are well known in the art, and may operate by way of resistive, capacitive, surface wave, infrared, strain gauge, optical imaging, dispersive imaging technology, and acoustic pulse recognition techniques. For example, in a resistive touch sensor, pressure applied to thin metallic electrically conductive and resistive layers cause a change in an electrical potential that is measured by a touch input sensor 690. Piezoelectric materials, which provide a varying electric potential based on applied pressure, may be utilized in the touch sensor 580. The touch input processor 690 processes input from the touch sensor 680 and provides touch measurements to the processor 610, thereby allowing a user of the portable electronic device 600 to use the adaptable skin 640 as an input device. The touch sensor 680 may be incorporated into the adaptable skin 640, or placed above or beneath the adaptable skin 640 based on the type of portable electronic device, its functionality, and designer preference.

As previously mentioned, the portable electronic device 600 is purely for illustrative purposes a mobile telephone. The wireless communication functionality 660 may be removed or replaced with other functionality based on the particular application of the portable electronic device 600.

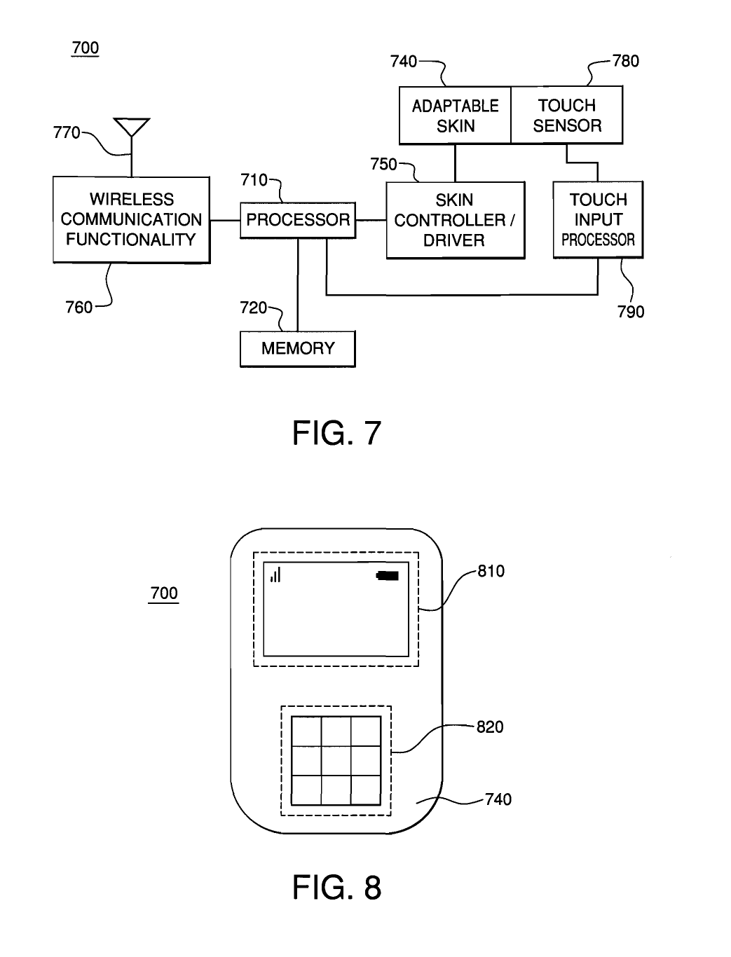

In another preferred embodiment, referring to FIG. 7, a block diagram of a portable electronic device 700 having only an adaptable skin is shown. As previously described with reference to FIGS. 5 and 6, portable electronic device 700 includes a processor 710, memory 720, adaptable skin 740, skin controller/driver 750, wireless communication functionality 760 including an antenna 770, a touch sensor 780 and a touch input processor 790. In this embodiment, the adaptable skin 740 performs the functions of a typical LCD, including displaying information to a user of the device 700.

To better illustrate the portable electronic device 700, reference is made to FIG. 8. The touch sensing adaptable skin 740 is configured to display an information pane 810 and a numeric keypad pane 820. These panes are configurable based on operator preference. Various other functional panes may be selected, such as a keyboard pane, a camera viewfinder pane, and the like. The size, shape, placement, appearance, and function of the various panes may be customized based on user preference. In conjunction with the touch sensor capability of the portable electronic device, a programmable, highly customizable input/output device is realized.

In another embodiment, the portable electronic device 700 includes one or a plurality of piezoelectric elements on, in, or under the adaptable skin 740. As mentioned above, since the adaptable skin 740 will typically not perfectly hold a written image for an indeterminate amount of time, a refresh charge may need to be periodically applied to ensure the adaptable skin 740 maintains a uniform appearance. The electrical potential created by the piezoelectric element when the portable electronic device 700 is handled by a user is captured for refreshing the adaptable skin 740. Additionally, when the adaptable skin is electrochromic based, a photochromic effect may be captured and used for refreshing the adaptable skin 740. Compensating for a leakage current of the adaptable skin 740 may also be accomplished by a sensor feedback mechanism, wherein a sensor embedded in the skin senses the color, charge, or other characteristic of the adaptable skin 740, and is driven by the skin controller/driver 750.

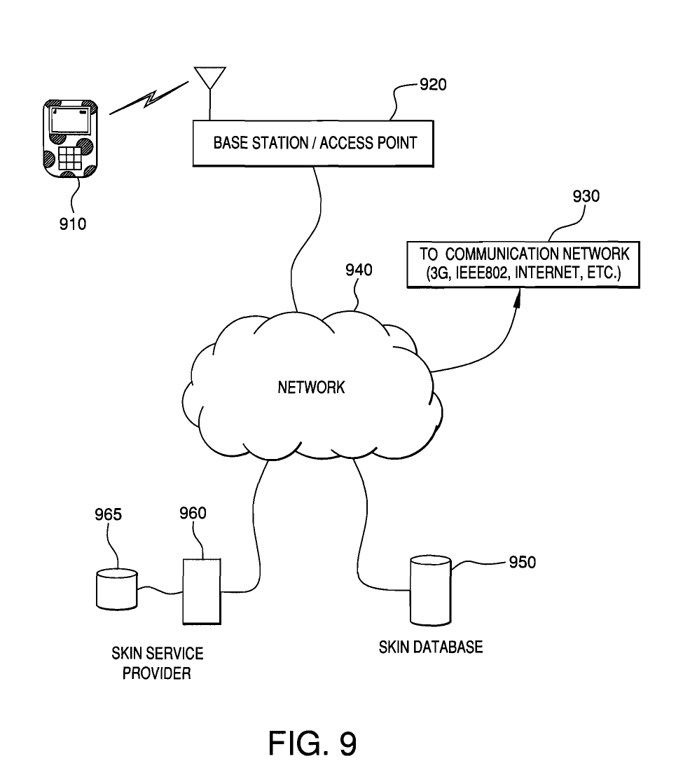

Referring to FIG. 9, a wireless communication network 900 capable of supporting skin image files on portable electronic devices is shown. A portable electronic device 910 includes wireless communication functionality that allows wireless communication with base station/access point 920. The wireless communication technology may be any wireless communication technology, as disclosed above. The base station/access point 920 is connected to its respective communication network 930 via a network 940, which may be an Internet protocol (IP) network. In the case where portable electronic device 910 is a mobile telephone, the communication network 930 would include various equipment that is operated and maintained by the service provider of the mobile phone. In the case where the portable electronic device is an IEEE 802.x compliant device, the base station/access point 920 may be a wireless access point and/or router and the communication network 930 may be the Internet. It is noted that portable electronic device 910 may be compliant with a plurality of wireless communication technologies, and may request and receive skin image files over any network.

A skin database 950 is connected to the network 940 and is configured to store skin image files. A service provider may store skin image files in the skin database 950 for purchase by a user, or a user may design a custom skin image file and store the skin image file in the skin database 950.

Optionally, a skin service provider 960 is connected to the network and provides skin image files to the portable electronic device 910 based on its location and function. Preferably, the skin service provider 960 includes a local database 965 for storing skin image files. However, the skin service provider 960 may alternatively use the skin database 950. The skin service provider 960 determines the location of the portable electronic device 910 using various methods, such as by way of a global positioning system (GPS) signals forwarded by the device 910, triangulation of base station or access point signals, identifying a base station or access point communicating with the device 910. When the device is determined to be within a predetermined area, the skin service provider 960 retrieves a skin image file from the local database 965, if it exists, or the skin database 950 and forwards the skin image file to the portable electronic device 910 via the network 940 and the base station/access point 920. In this manner, the skin service provider 960 provides relevant, timely skins to a portable electronic device 910 having an adaptable skin.

Subscription services may be provided by the skin service provider 960. For example, a user of the portable electronic device 910 may enroll in a coupon program, wherein the skin service provider 960 provides relevant skin image files to the device 910. Coupons of nearby products may appear on the skin of the portable electronic device 910 while the user browses store shelves. Content providers could subsidize a user's fee for accessing certain networks based on the user's enrollment in a subscription program.

Functionality of the portable electronic device may change based on the skin image file provided to the portable electronic device 910 as well. For example, a user of the portable electronic device 910 may be a preferred member of a local coffee shop. One of the benefits of this membership may be free access to the shop's wireless local area network (WLAN). The skin service provider 960 recognizes the user's membership and provides as part of the skin image file information for altering the functionality of the device 910, in this case information relating to the WLAN, such as security settings. The displayed skin would preferably indicate the altered functionality. In the case where the portable electronic device includes a touch sensor as described above, the skin could include functional icons that could be selected in conjunction with the touch sensor.

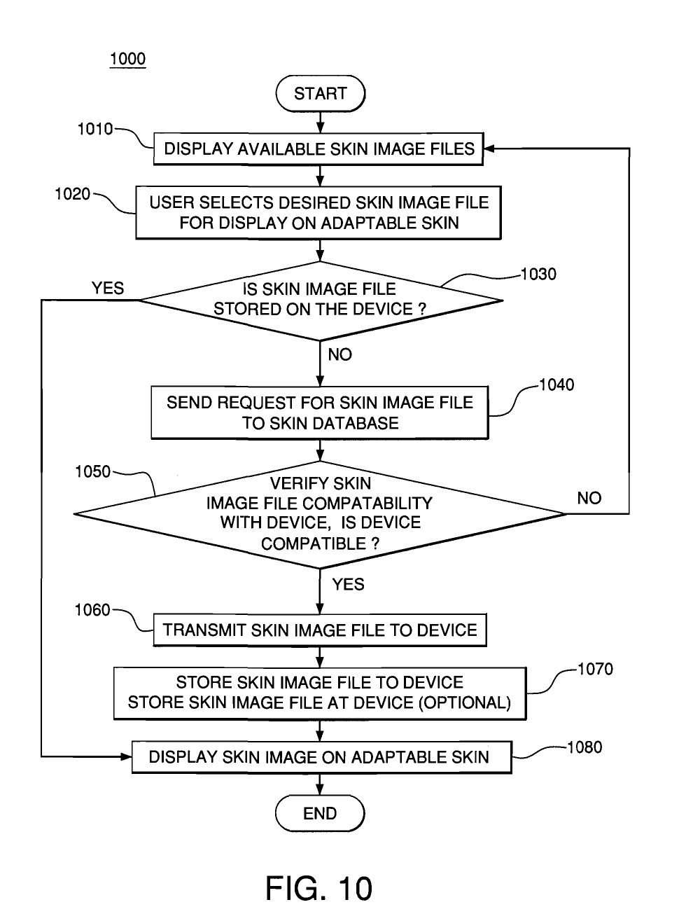

Referring to FIG. 10, a method 1000 for a user of portable electronic device to request skin image files is shown. In this embodiment, the portable electronic device includes wireless communication functionality. Available skins are displayed to the user on the display of the device, (step 1010). Thumbnails or icons representative of the skin as it would appear on the portable electronic device are preferably displayed. A user may then select a desired skin image file for display on the adaptable skin of the device, (step 1020). In order to prevent needless signaling with a communication network, the portable electronic device determines whether a copy of the skin image file is stored locally, (step 1030). If a copy of the skin image file is stored locally, the method advances to step 1080 where the skin image is displayed on the adaptable skin of the device. If a copy of desired skin image file is not stored locally, a request for the skin image file is sent to the skin image database, (step 1040). The compatibility of the skin image file with the adaptable skin is determined, (step 1050). The compatibility of the skin image file with the adaptable skin is based on skin image file parameters, that may include, author of the file, size of the file, size of the skin for which the file is designed, resolution required to display the file, and cost associated of the file.

When it is determined that the requested skin image file is not compatible with the requesting portable electronic device, the method 1000 returns to step 1010 and removes the requested skin from the list of available skin image files. When it is determined that the requested skin image file is compatible with the portable electronic device, the skin image file is transmitted to the device, (step 1060). Optionally, based on device configuration and hardware availability, a local copy of the transmitted skin image file is stored at the portable electronic device, (step 1070). Finally, the skin image file is displayed on the adaptable skin, (step 1080).

Preferably, in step 1010 where the available skin image files are displayed to the user, an interactive window including a search pane for a user to search the online database, a library pane for providing a hierarchical view of the skin files in the database, a play list pane for providing a list of skin file to the user, and a channels pane providing a list of preprogrammed theme channels available through the skin database is provided. Additionally, a user may set a scheduled playtime for the selected skin selections.

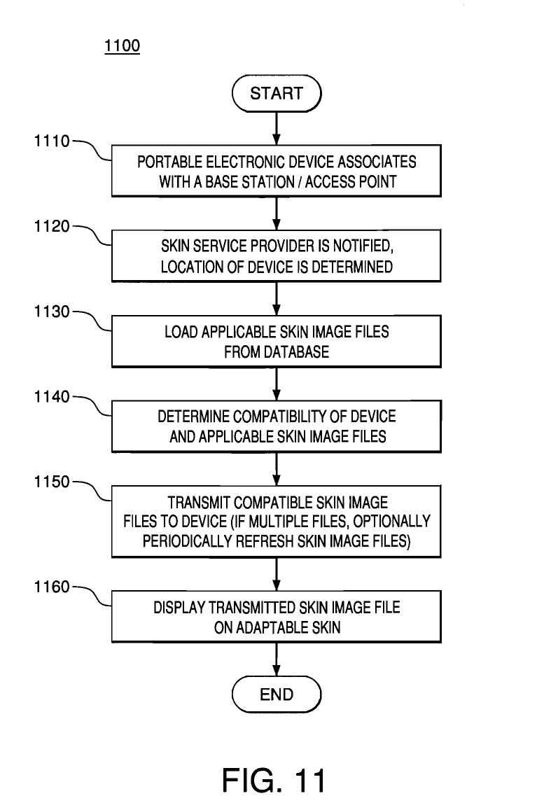

In another embodiment, referring to FIG. 11, a method 1100 for providing skin image files to a portable electronic device based on the device's location is shown. In this embodiment, the portable electronic device includes wireless communication functionality. When the portable electronic device enters the range of a wireless base station or access point, the device will associate with the base station or access point, (step 1110). Various association procedures may be employed based on the type of wireless communication system used. A skin service provider is notified that an association has been made, and the location of the portable electronic device is determined, (step 1120). The skin device provider may determine location using various methods, including physical positioning of the base station or access point, and GPS location measurements, for example. Applicable skin image files relating to the determined location are loaded, (step 1130). Skin image files are determined to be compatible with the portable electronic device, (step 1140). The compatible skin image files are transmitted to the device, (step 1150). In the case where there are multiple compatible skin image files, the skin service provider may periodically update the skin image file on the portable electronic device, thereby cycling through the compatible skin image files. Alternatively, each skin image file may be given a priority, and in the case where multiple skin image files are compatible with a given device, the file with the highest priority is transmitted to the device. Finally, the transmitted skin image file is displayed on the device's adaptable skin, (step 1160).

In another embodiment, the portable electronic device itself contains a skin image file database capable of maintaining a plurality of skin image files for display on a adaptable skin. Each skin image file is associated with an identifier, such as a telephone number or IP address. When the portable electronic device is paged for the receipt of an incoming communication session, the call's initiator identification will be provided. The portable electronic device displays the skin image file associated with the caller's identification on the adaptable display.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A portable electronic device comprising:
a memory configured to store a skin image file;
an adaptable skin substantially covering the portable electronic device, wherein the skin is configured to display a stored skin image; and
electronics configured to drive and control the adaptable skin.

2. The portable electronic device of claim 1, wherein the adaptable skin is an adaptable electrochromic skin.

3. The portable electronic device of claim 1, further comprising:
a transceiver configured to send requests for a skin image files to a server.

4. The portable electronic device of claim 3, wherein the transceiver is further configured to receive skin image files from the server.

5. The portable electronic device of claim 1, further comprising:
a display configured to list skin image files available for display on the adaptable skin of the device.

6. The portable electronic device of claim 5, wherein the list of skin image files includes skin image files stored locally in the memory of the device.

7. The portable electronic device of claim 5, further comprising:
an input device configured to select a skin image for display by the adaptable skin.

8. The portable electronic device of claim 5, wherein the display is configured to display an interactive window comprising:
a search pane wherein a user is able to search an electronic database for skin image files;
a library pane configured to display a hierarchical view skin image files stored in the database;
a play list pane configured to display a list of skin image files to the user; and
a channels pane configured to provide a list of preprogrammed theme channels available in the electronic database, wherein the preprogrammed theme channels include a plurality of related skin image files.

9. The portable electronic device of claim 1, wherein the portable electronic device is a mobile telephone, and a specific skin image file is displayed on the adaptable skin upon receipt of a call.

10. The portable electronic device of claim 9, wherein a unique skin image file is displayed based on an identification of the call.

11. The portable electronic device of claim 10, wherein the identification of the call is a telephone number.

12. The portable electronic device of claim 10, wherein the identification of the call is an Internet protocol (IP) address.

13. A system for delivering skin image files, the system comprising:
a wireless communication network including at least one base station;
a skin database configured to store skin image files; and
a portable electronic device comprising:
an adaptable skin substantially covering the portable electronic device, wherein the skin is configured to display a skin image file; and
a transceiver configured to send requests for skin image files to the skin database and to receive skin image files from the skin database.

14. The system of claim 13, wherein the adaptable skin of the portable electronic device is an adaptable electrochromic skin.

15. The system of claim 14, wherein the portable electronic device further comprises:
a display configured to display a list of skin image files available for display on the adaptable skin of the device.

16. The system of claim 15, wherein the list of skin image files includes skin image files stored locally in a memory of the portable electronic device.

17. The system of claim 15, wherein the portable electronic device further comprises:
an input device configured to select a skin image for display by the adaptable skin.

18. The system of claim 15, wherein the display is configured to display an interactive window comprising:
a search pane wherein a user is able to search an electronic database for skin image files;
a library pane configured to display a hierarchical view skin image files stored in the database;
a play list pane configured to display a list of skin image files to the user; and
a channels pane configured to provide a list of preprogrammed theme channels available in the electronic database, wherein the preprogrammed theme channels include a plurality of related skin image files.

19. The system of claim 13, wherein the portable electronic device is a mobile telephone, and a specific skin image file is displayed on the adaptable skin upon receipt of a call.

20. The system of claim 19, wherein a unique skin image file is displayed based on an identification of the call.

21. The system of claim 20, wherein the identification of the call is a telephone number.

22. The system of claim 20, wherein the identification of the call is an Internet protocol (IP) address.

23. The system of claim 13, wherein the skin database is further configured to track the number and type of skin image files transmitted to a portable electronic device for charging purposes.

24. The system of claim 13, wherein the wireless communication network is an IEEE 802.x wireless local area network (WLAN).

25. The system of claim 13, wherein the wireless communication network is a global system for mobile communications (GSM) network.

26. The system of claim 13, wherein the wireless communication network is a third generation partnership project (3GPP) network.

27. The system of claim 13, further comprising:
a skin service provider configured to provide skin image files to the portable electronic device based on the location of the portable electronic device.

28. The system of claim 27, wherein the skin service provider is further configured to determine the location of the portable electronic device based on the portable electronic device's association with the base station.

29. The system of claim 27, wherein the portable electronic device further comprises:
a global positioning system (GPS) circuit for providing location information to the skin service provider;
wherein the skin service provider determines the location of the portable electronic device based on the provided location information.

30. The system of claim 27, wherein the skin service provider includes:
a database of skin image files corresponding to a plurality of locations;
wherein when a portable electronic device is positioned at one of the plurality of locations the skin service provider is configured to select a skin image file corresponding to the one location.

31. A portable electronic device comprising:
an adaptable skin substantially covering the portable electronic device, wherein the skin is configured to display a stored skin image including information for display to a user;
a touch sensor proximately disposed to the adaptable skin, wherein the touch sensor is configured to receive touch input from a user of the portable electronic device;
electronics configured to drive and control the adaptable skin and to process the touch input from the touch sensor; and
a memory configured to store a skin image file for display on the adaptable skin.

32. The portable electronic device of claim 31, wherein the adaptable skin is an adaptable electrochromic skin.

33. The portable electronic device of claim 31, further comprising:
a transceiver configured to send requests for a skin image files to a server.

34. The portable electronic device of claim 33, wherein the transceiver is further configured to receive skin image files from the server.

35. The portable electronic device of claim 31, wherein the adaptable skin is configured to display an interactive window comprising:
a search pane wherein a user is able to search an electronic database for skin image files;
a library pane configured to display a hierarchical view skin image files stored in the database;
a play list pane configured to display a list of skin image files to the user; and
a channels pane configured to provide a list of preprogrammed theme channels available in the electronic database, wherein the preprogrammed theme channels include a plurality of related skin image files.

36. The portable electronic device of claim 35, wherein the portable electronic device is a mobile telephone, and a specific skin image file is displayed on the adaptable skin upon receipt of a call.

37. The portable electronic device of claim 36, wherein a unique skin image file is displayed based on an identification of the call.

38. The portable electronic device of claim 37, wherein the identification of the call is a telephone number.

39. The portable electronic device of claim 38, wherein the identification of the call is an Internet protocol (IP) address.
